(19) United States
(12) Patent Application Publication
(10) Pub. No.: US 2012/0183181 A1
(43) Pub. Date: Jul. 19, 2012

(54) ELECTRONIC DEVICE AND DISPLAY CONTROL METHOD THEREOF

(75) Inventor: QIANG YOU, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/221,912

(22) Filed: Aug. 31, 2011

(30) Foreign Application Priority Data
Jan. 14, 2011 (CN) 201110007623.8

(51) Int. Cl. G06K 9/00; G09G 5/00

(52) U.S. Cl. 382/118; 345/204

(57) ABSTRACT

An electronic device includes a display unit, a detecting unit, a timing unit, a judging unit, a distance calculating unit, and a controller. The display unit displays desired information. The detecting unit detects nearby persons and generates a signal when at least one unauthorized person is detected within a predetermined distance of the electronic device. The timing unit receives the detecting signal and times duration during which the detecting signal is continuously generated. The judging unit judges whether the timed duration reaches a predetermined time period and generating a distance calculating signal if the timed duration reaches the time period. The distance calculating unit calculates the distance between the at least one unauthorized person and the electronic device in response to the distance calculating signal. The controller adjusts the display parameters of the display unit according to the calculated distance.

### BACKGROUND

1. Technical Field

The present disclosure relates to electronic devices, and more particularly, to an electronic device having displaying function and a display control method thereof.

2. Description of Related Art

Nowadays, users often keep personal information like usernames and passwords in electronic devices for convenient access. However, when viewing the information, others may view the information, which presents a security risk.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device in accordance with an embodiment.

FIG. 2 is a flowchart of a display control method in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

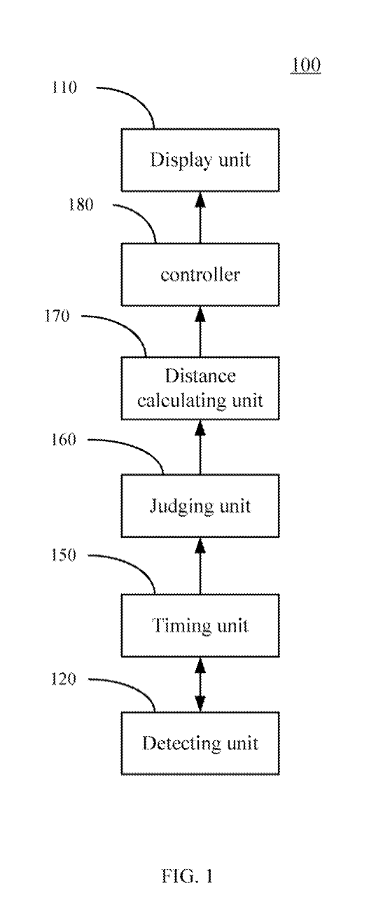

Referring to FIG. 1, an electronic device 100 includes a display unit 110, a detecting unit 120, a timing unit 150, a judging unit 160, a distance calculating unit 170, and a controller 180. The display unit 110 is used for displaying information, such as images, videos, and user input. In some embodiments, the electronic device 100 may be a notebook computer or a mobile phone.

The detecting unit 120 is used for detecting nearby persons and generates a signal when at least one unauthorized person is detected within a predetermined distance of the electronic device 100. The detecting unit 120 continues to generate the signal until the area within the predetermined distance is clear. In some embodiments, the detecting unit 120 may use known technologies such as ultrasonic distance detecting technology, facial recognition technology, or infrared detecting technology to detect nearby persons.

The timing unit 150 is electrically connected to the detecting unit 120, and is used for timing a duration during which the detecting signal is continuously generated. The timing unit 150 resets the timed duration when no signal from the detecting 120 is received.

The judging unit 160 is electrically connected to the timing unit 150 and is used for judging whether the timed duration reaches a predetermined time period. The judging unit 160 determines that the at least one unauthorized person may be viewing the information displayed in display unit 110 and generates a distance calculating signal if the timed duration reaches the predetermined time period. In some embodiments, the predetermined time period can be set by the user or the manufacturer of the electronic device 100. In the illustrated embodiment, the predetermined time period is preset to be one minute.

The distance calculating unit 170 is electrically connected to the judging unit 160, and is used for calculating the distance between the at least one unauthorized person who may be viewing the information and the electronic device 100 in response to the distance calculating signal. In some embodiments, the distance calculating unit 170 may calculate the distance using known distance measuring technologies such as ultrasonic measuring devices.

The controller 180 is electrically connected to the distance calculating unit 170 and the display unit 110, and is used for adjusting display parameters of the display unit 110 according to the distance calculated by the distance calculating unit 170 to prevent the at least one unauthorized person from viewing the information displayed on the display unit 110 clearly. In the embodiment, the controller 180 can adjust font size or font color of the desired information, such that the information cannot be easily seen from a certain distance. In other embodiments, the controller 180 can adjust other display parameters such as the brightness, the contrast or the resolution of the display unit 110 to prevent the at least one unauthorized person from viewing the information displayed on the display unit 110 clearly.

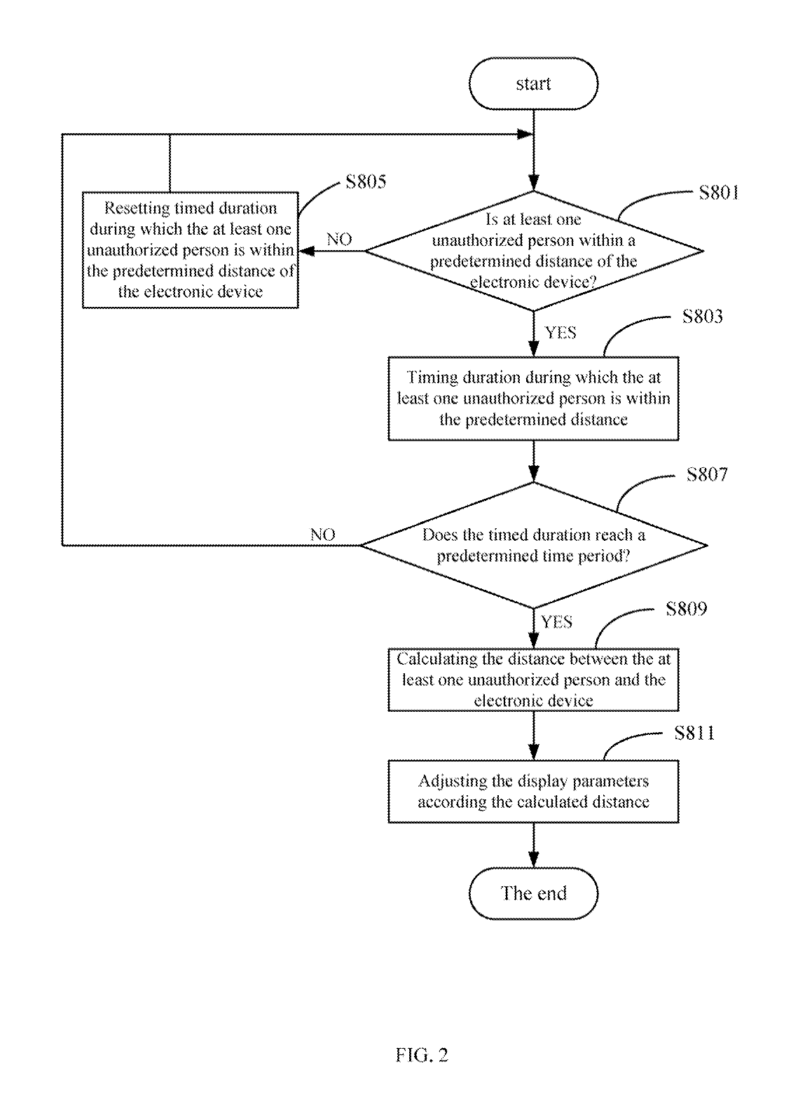

Referring to FIG. 2, a display control method applied in the electronic device 100 is provided to prevent unauthorized persons near the electronic device 100 from viewing the information displayed in the display unit 110. The display control method includes the following steps:

In step S801, the detecting unit 120 checks for persons within a predetermined distance of the electronic device 100. If at least one unauthorized person is detected within the predetermined distance, step S803 is implemented; if no one is detected, return to step S801. The detecting unit 120 generates a signal if at least one unauthorized person is detected within the predetermined distance and generates no signal if no one is detected within the predetermined distance. The detecting unit 120 continuous to generate the signal until the area within the predetermined distance is clear.

In step S803, the timing unit 150 times duration during which the signal is continuously generated by the detecting unit 120.

In step S805, the timing unit 150 resets the timed duration if no signal from the detecting unit 120 is received such that the detecting unit 120 can detect whether at least one unauthorized person is in the predetermined distance of the electronic device 100 in the next detecting cycle.

In step S807, the judging unit 160 judges whether the timed duration reaches the predetermined time period. If the timed duration reaches the predetermined time period, a conclusion that the at least one authorized person may be viewing the information displayed in the display unit 110 is drawn and step S809 is implemented. If the timed duration does not reach the predetermined time period, return to step S801. In the illustrated embodiment, the predetermined time period may be any preset time interval.

In step S809, the distance calculating unit 170 calculates the distance between the at least one unauthorized person who is judged to be viewing the information and the electronic device 100.

In step S811, the controller 180 adjusts the display parameters of the display unit 110 according to the distance between the electronic device 100 and the at least one unauthorized person such that the person is prevented from viewing the information displayed in the display unit 110 clearly. In some embodiments, the controller 180 adjusts font size or font color of the information. In other embodiments, the controller 180 may adjust display parameters of the display unit 110 such as the brightness, the contrast, or the resolution.

It is to be understood, however, that even though information and the advantages of the present embodiments have been set forth in the foregoing description, together with details of the structures and functions of the present embodiments, the disclosure is illustrative only; and that changes may be made in detail, especially in matters of shape, size, and arrangement of parts within the principles of the present embodiments to the full extent indicated by the broad general meaning of the terms in which the appended claims are expressed.

What is claimed is:

1. An electronic device, comprising:
a display unit for displaying desired information;
a detecting unit for detecting nearby persons and generating a signal when at least one unauthorized person is detected within a predetermined distance of the electronic device;
a timing unit for receiving the signal and timing duration during which the signal is continuously generated;
a judging unit for judging whether the timed duration reaches a predetermined time period and generating a distance calculating signal if the timed duration reaches the time period;
a distance calculating unit for calculating the distance between the at least one unauthorized person and the electronic device in response to the distance calculating signal; and
a controller for adjusting display parameters of the display unit according to the distance between the at least one unauthorized person and the electronic device to prevent the at least one unauthorized person from viewing the desired information.

2. The electronic device as claimed in claim 1, wherein the detecting unit generates no signal when no one is detected within the predetermined distance of the electronic device, the timing unit resets the timed duration if no signal from the detecting unit is received.

3. The electronic device as claimed in claim 1, wherein the detecting unit is capable of capturing images of the environment surrounding the electronic device and selecting facial features from the images, the detecting unit compares the selected facial features and a facial database to detect whether an unauthorized person is in the predetermined distance of the electronic device.

4. The electronic device as claimed in claim 3, wherein the detecting unit determines that an unauthorized person is within the predetermined distance of the electronic device when at least one facial feature different from a predetermined face image is recognized in the image.

5. The electronic device as claimed in claim 4, wherein the distance calculating unit calculates the distance between the electronic device and the at least one unauthorized person according to the size of the facial feature of the at least one unauthorized person.

6. The electronic device as claimed in claim 1, wherein the detecting unit comprises an ultrasonic sensor for detecting the distance between the electronic device and each nearby person, the detecting unit determines that at least one unauthorized person is within the predetermined distance of the electronic device when the distance between at least one nearby person and the electronic device is smaller than a predetermined distance value.

7. The electronic device as claimed in claim 1, wherein the detecting unit comprises an infrared sensor for detecting the thermal value in the environment surrounding the electronic device, the detecting unit determines that at least one unauthorized person is within the predetermined distance of the electronic device when the thermal value is higher than a predetermined thermal value.

8. The electronic device as claimed in claim 1, wherein the display parameters comprises the character size and character color of the desired information.

9. The electronic device as claimed in claim 8, wherein the display parameters comprises brightness, contrast, or resolution of the display unit.

10. A display control method for controlling display function of an electronic device, the display control method comprising:
detecting whether at least one unauthorized person is within a predetermined distance of the electronic device;
timing a duration during which the at least one unauthorized person is within the predetermined distance;
judging whether the timed duration reaches a predetermined time period or not;
calculating the distance between the at least one unauthorized person and the electronic device if the timed duration reaches the predetermined time period; and
adjusting the display parameters of a display unit of the electronic device according to the distance between the at least one unauthorized person and the electronic device such that the person can not view the desired information clearly.

11. The display control method as claimed in claim 10, wherein the display control method further comprises the step of resetting the timed duration if no one is detected in the predetermined distance of the electronic device.

12. The display control method as claimed in claim 10, wherein the display control method further comprises the step of returning to the step of determining whether at least one unauthorized person in the predetermined distance of the electronic device if the timed duration does not reach the predetermined time period.

13. The controlling method as claimed in claim 10, wherein the display parameters comprises character size and character color of the desired information.

14. The display control method as claimed in claim 10, wherein the display parameters comprises brightness, contrast, or resolution of a display unit of the electronic device.

15. The display control method as claimed in claim 10, wherein a signal is generated when at least one unauthorized person is detected within the predetermined distance and no signal is generated when no one is detected within the predetermined distance.

16. The display control method as claimed in claim 15, wherein the display control method further comprises the step of continuous to generate the signal until the area within the predetermined distance is clear.
